(19) United States
(12) Patent Application Publication
(10) Pub. No.: US 2018/0311919 A1
(43) Pub. Date: Nov. 1, 2018

(54) LIGHTER THAN AIR, LONG LIFE POLYESTER ENVELOPE EMBOSSED WITH HOLOGRAPHIC PATTERNS

(71) Applicant: TORAY PLASTICS (AMERICA), INC., North Kingstown, RI (US)

(72) Inventors: Milan W. MOSCARITOLO, Westerly, RI (US); Tracy A. PAOLILLI, East Greenwich, RI (US); Joshua R. CLOUTIER, Exeter, RI (US); John J. FITCH, Middletown, RI (US)

(21) Appl. No.: 15/790,574

(22) Filed: Oct. 23, 2017

Related U.S. Application Data
(60) Provisional application No. 62/491,878, filed on Apr. 28, 2017.

(51) Int. Cl. B29D 22/02; B64B 1/58; B64B 1/40; B32B 3/30; B32B 27/08; B32B 27/36; B32B 27/32; B32B 27/30; A63H 27/10

(52) U.S. Cl. CPC B29D 22/02; B64B 1/58; B64B 1/40; B32B 3/30; B32B 27/08; B32B 27/36; B29K 2067/003; B32B 27/306; A63H 27/10; B32B 2307/7246; B32B 2307/7244; B32B 2451/00; B32B 27/32

(57) ABSTRACT

A lighter-than-air holographic envelope such as a balloon decorated with a holographic pattern and having long float life (one week or longer) comprises a metal layer, an embossable layer, and a polymeric gas barrier of polyvinyl alcohol/polyvinyl amine copolymer crosslinked with citric acid and an optional additional crosslinking agent such as epichlorohydrin and a heat-seal layer.

### CROSS REFERENCE TO RELATED APPLICATION

This patent application claims benefit of U.S. provisional application No. 62/491,878, filed Apr. 28, 2017, and is incorporated by reference herein in its entirety.

### FIELD OF INVENTION

This invention relates to a lighter than air envelope such as balloon/airship decorated with a holographic pattern and having long float life (greater than one week) comprising a metal layer, an embossable layer, a polymeric gas barrier layer of polyvinyl alcohol/polyvinyl amine copolymer crosslinked with citric acid and an optional additional crosslinking agent such as epichlorohydrin, and a heat-seal layer.

### BACKGROUND OF INVENTION

Decorated balloons formed from film laminates comprising a polyester film layer (and commonly referred to as “Mylar® balloons”) have been gaining increasing popularity vs. conventional latex balloons in view of their ability to be printed with vividly colorful images and more versatile and attractive appearance such as a Valentine's Day heart shape, flower shapes, animal shapes, any famous character printing thereon and so on.

A balloon/airship is an embodiment of an envelope containing a lighter-than-air gas such as helium. In addition to polyester, such as highly crystalline polyethylene terephthalate (PET) oriented film layer (“base film”), film laminates used in balloon construction typically comprise metallization for improved gas barrier, which facilitates substantially permanent buoyancy. Alternatively a polymeric gas barrier layer can be applied, in addition to or in place of the metallization layer, such as those described in U.S. Pat. No. 8,236,399 or U.S. Pat. No. 9,617,059.

Since the envelope is made by bonding together two initially flat laminated panels, it is also essential that a good sealant material is present in the laminate to facilitate good bonding of the panels, capable of resisting the forces of inflation and durable over long periods. An extrusion-coated polyethylene layer, on the surface of the base film opposite to the gas barrier-coated surface, which is activated by heat sealing at a temperature above the melting point of polyethylene but below the melting point of PET, is a preferred method of providing good bonding.

Polyester balloons are typically decorated with paint and ink patterns applied on the metalized surface. A more recent decorating innovation is holographic patterns. Holograms and diffraction gratings are images that diffract light created by the texturizing of a substrate under heat and pressure. Such images are used to create decorative packaging, security products and a host of other uses. The embossed substrates are often metalized to create high contrast. Such metalized substrates are found on credit cards, membership materials, board laminates such as packaging materials, labels, toys and many commodity products. In the case of holographic images developed on polyester film, such patterns are typically obtained by applying an embossable thermoplastic polymeric coating on the base film, followed by applying a shim under pressure, which embosses the holographic diffraction grating on the embossable coating. Much like the traditional vinyl record printing process, the pattern is embossed by heat and pressure from a metal or polymer stamp (“shim”) onto a thermoplastic medium. This is followed by metal deposition for high contrast. Since the grating grooves are in the order of magnitude of light wavelengths, these holographic patterns cause diffraction of incident light, resulting in light interference giving multiple colors which vary with the angle of observation or in 3D images.

By using metal deposition on top of the embossed holographic pattern, the metal coating preserves the holographic pattern. As a consequence, metal imperfections, such as pinholes and gaps are possible, which compromise the other typical function of the metal coating, i.e. the gas barrier. In addition, the processes of balloon fabrication being severe, they may cause additional damage to the metallization layer in proximity to the embossed coating. Because of that, balloons with holographic decoration have to-date been characterized by limited shelf life: for example currently commercial holographic metalized balloons, which comprise 40-48 G (10-12 um) thick nylon base film, demonstrated only 4-7 days float life as opposed to 15-20 days typical of standard metalized balloons. (The term “G” is an abbreviation of film thickness unit “gauge”, which equals to 0.01 mil or about 0.25 μm.) Attempts to improve the gas barrier performance of holographic-decorated films based on nylon-based film by adding additional barrier layers have not been reported, probably because nylon does not lend itself directly to such barrier coating methods such as polymeric barrier coatings.

There remains therefore a need for a balloon film and a balloon with metalized holographic decoration that has improved barrier, exceeding 7 days and going as far as 15-20 days or longer. In addition, it is desirable that such a balloon comprises a polyester base film, preferably a 36 G (9.0 μm) thick polyester film, since this is the prevalent and most economical base material in the balloon industry. To-date, the inventors are not aware of anyone producing holographic balloons base on 36 G polyester base film.

### SUMMARY OF THE INVENTION

The present disclosure is generally related to lighter-than-air polyester balloon film laminations and balloons made thereof, decorated with a metalized holographic pattern and including a high gas barrier polymeric layer, float life of the balloon is 10 days or longer, preferably 20 days or longer. The lamination may include co-extruded and biaxially oriented polyester film.

Embodiments disclosed herein include a composite film structure (FIG. 1) of a total thickness between about 20-40 μm, comprising:

1) A coextruded, biaxially oriented base film (A) including a first high crystalline polyester layer (a); a second amorphous, optionally copolyester layer (b); wherein the first high crystalline polyester core layer (a) and the second amorphous polyester skin layer (b) are co-extruded and biaxially oriented to form a multilayer oriented base film (A). The base film (A) has a thickness 16-48 G (4-12μ), preferably 36 G (9 μm).
2) A polymeric gas barrier layer (B) coextensively adjacent and in direct contact with the base layer (A). The barrier layer composition is a polymer including polyvinyl amine monomer which is crosslinked with citric acid. Preferably the polymer is polyvinyl alcohol/polyvinyl amine copolymer (PVOH/PVA). The crosslinked product of the polyvinyl amine polymer is sometimes referred to as “modified PVA polymer” or “mPVA”. A crosslinking agent in addition to citric acid, such as epichlorohydrin, optionally can be included to form the mPVA material. The barrier layer can be applied, preferably by an inline coating process to either side of the base film (A). In a preferred embodiment, the barrier layer is applied to the highly crystalline side (a) of the base film (A).
3) A sealant layer (C) coated or laminated onto the polyester base film (A). The sealant layer is applied onto the opposite side of the base film (A) versus the barrier coating layer (B). Preferably the sealant layer is applied onto the amorphous skin side (a) of the polyester film (A). The sealant layer is a low density or linear low density polyethylene, preferably linear low density polyethylene. The thickness of the sealant layer is 12-25 μm (48-100 G), preferably around 14 μm.
4) The balloon film may further include an anchor layer (D), typically a primer, between the sealant layer (C) and the amorphous copolyester skin layer (a) to facilitate adhesion of the sealant layer onto the base film.
5) An embossed coating layer (E) applied onto the polymeric barrier coating (B). The embossable material of that coating may be a thermo-sensitive material such as polyethylene, polystyrene, polyvinyl chloride and styrene butadiene like thermoplastics, polyester or polyester-acrylic copolymer or semi-cured thermosets which have discernible thermoplastic properties, such as polyesters or polyester-acrylic copolymers.
6) A metal deposition layer (F), such as aluminum or other suitable materials such as ZnS.

Additional advantages of this invention will become readily apparent to those skilled in this art from the following detailed description, wherein only the preferred embodiments of this invention is shown and described, simply by way of illustration of the best mode contemplated for carrying out this invention. As will be realized, this invention is capable of other and different embodiments, and its details are capable of modifications in various obvious respects, all without departing from this invention. Accordingly, the drawings and description are to be regarded as illustrative in nature and not as restrictive.

### BRIEF DESCRIPTION OF THE DRAWING

FIG. 1 is a schematic of a cross-sectional view of a film laminate 1 in accordance with one possible embodiment. Precursor laminates marked 11 and 12 represent the first two stages of the manufacturing, as explained in the specifications. At the end of each manufacturing step the corresponding first stage and second stage precursor laminates (structures 11 and 12 respectively) could be wound-up in a roll and transferred to the next stage. The final step makes the overall film laminate 1.

### DETAILED DESCRIPTION OF THE INVENTION

It should be noted that the terms “laminate” and “lamination” in the context of this application refers to a layered film structure and any method of putting together a layered film structure, i.e. including extrusion coating, solution coating, inline or offline aqueous dispersion coating, other forms of deposition, and is not restricted to a narrower definition of the term “lamination” which refers to putting two or more pre-existing films together. In one embodiment the embossable coating may be a thermo-sensitive material such as polyethylene, polystyrene, polyvinyl chloride and styrene butadiene like thermoplastics or semi-cured thermosets which have discernible thermoplastic properties. Such processes for applying an embossable coating are described herein. For example, one such embossable coating comprises a polyester or a polyester-acrylic resin applied to the core layer of the polyester base film (PET film), wherein the coating and the PET film have as a composite been transversely stretched, the film being coated from an aqueous solution with a non-crosslinked polystyrene-acrylic emulsion or a non-crosslinked polyester dispersion or a mixture thereof, the Tg of the coating resin being greater than about 20° C., preferably greater than about 35° C., and less than about 70° C., the coating resin being capable of impregnating a surface of the PET film on drawing, rendering the film surface susceptible to embossing under pressure and the coating having low heat sealability. This is followed by an embossing pattern produced on the surface of the embossable coating opposite to the barrier coating layer.

Described herein are long-life holographic lighter-than-air polyester envelopes such as balloons, formed from a lamination. The lamination may include a polyester film that includes a biaxially oriented polyester core layer and an amorphous copolyester skin layer. The lamination also includes a sealant layer and a polymeric gas barrier layer on an opposite side of the polyester film from the sealant layer. The lamination also includes a metalized embossed layer that provides the holographic image.

The balloons may have an oxygen transmission rate of less than 0.1 cc/100 in²/day, a bonding strength of the gas barrier layer to the surface of the polyester film of more than 300 g/in at dry conditions, a sealing strength of the balloon of more than 3.5 kg/in, and a floating time of the balloon of more than 7 days, preferably more than 20 days.

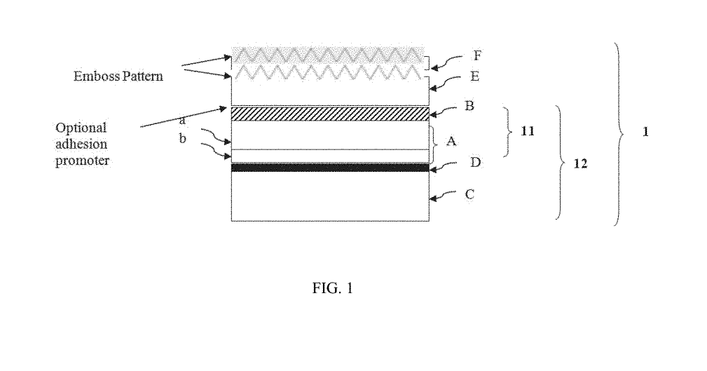

In embodiments, a film material for the balloon may include a thin, extensible, yet stress-crack resistant film material including two or more layers. The film may be prepared on, for example, a commercial biaxially orientation tentering film line. An embodiment shown in FIG. 1 includes a base film (A) including a first highly crystalline polyester layer (a) and a second, amorphous, copolyester layer (b). Preferably, the thickness of film (A) including layers (a) and (b) is 4-12 μm. The structure in FIG. 1 also includes a linear low density polyethylene (LLDPE) layer (C). The structure also includes a polymeric gas barrier layer (B), coated on the (a) (core) side of base film (A). Finally, the structure also includes an embossed layer (E), metalized by metal deposition layer (F).

### The Base Film Layer (A)

The high crystalline polyester core layer (a) can include any suitable material. For example, in embodiments, high crystalline polyester layer (a) includes high intrinsic viscosity (IV) homopolyesters such as PET or PEN or the copolyester of PET/PBT, for example, in embodiments, an intrinsic viscosity >0.50 or an IV of >0.60.

Crystallinity is defined as the weight fraction of material producing a crystalline exotherm when measured using a differential scanning calorimeter. For a high crystalline polyester, an exothermic peak in the melt range of 220° C. to 290° C. is most often observed. High crystallinity is therefore defined as the ratio of the heat capacity of material melting in the range of 220° C. to 290° C. versus the total potential heat capacity for the entire material present if it were all to melt. A crystallinity value of >35% weight fraction is considered high crystallinity.

The amorphous copolyester skin or sublayer (b) can include any suitable material. For example, in embodiments, amorphous copolyester layer (b) includes optionally isophthalate-modified copolyesters, sebacic acid-modified copolyesters, diethyleneglycol-modified copolyesters, triethyleneglycol-modified copolyesters, and cyclohexanedimethanol-modified copolyesters.

The materials selected for the various sublayers of base film (A) can include any suitable material. For example, in embodiments, the polyester of the crystalline layer (a) can be polyethylene terephthalate, polybutylene terephthalate, polyethylene naphthalate, polyethylene 2,5-furandicarboxylate, mixtures, polytrimethylene terephthalate, as well as copolymer or blend combinations thereof.

Further, in embodiments, the polyester of the amorphous layer (b) are selected from the group consisting of polyethylene terephthalate, polybutylene terephthalate, polypropylene terephthalate, polyethylenenaphthalate, mixtures, copolymers and combinations thereof, polyethylene terephthalate-co-isophthalate, poly(ethylene-co-1,4 cyclohexyldimethylene) terephthalate, polyethylene 2,5-furandicarboxylate.

In one set of embodiments film layer (a) is a polyester containing 70-99.9 wt. % (ethylene-terephthalate) repeat units, preferably crystalline polyethylene terephthalate, ranging in concentration between 99.6-99.9 wt. % based on layer (a) and can be uniaxially or biaxially oriented. These resins have intrinsic viscosities between 0.60 and 0.85 dl/g, a melting point of about 255-260° C., a heat of fusion of about 30-46 J/g, and a density of about 1.4.

The layer (a) can further include other additives. Additional preferred additives in the layer include antiblock and slip additives. These are typically solid particles dispersed within the layer effectively to produce a low coefficient of friction on the exposed surface of the layer. This low coefficient of friction helps the film to move smoothly through the film formation, stretching and wind-up operations. Without such antiblocking and slip additives, the outer surfaces would be more tacky and would more likely cause the film being fabricated to stick to itself and to processing equipment causing excessive production waste and low productivity. Examples of antiblock and slip additives that may be used for polyester film applications include amorphous silica particles with mean particle size diameters in the range of 0.05-0.1 μm at concentrations of 0.1-0.4 mass-percent, calcium carbonate particles with a medium particle size of 0.3-1.2 μm at concentrations of 0.03-0.2 mass-percent. Precipitated alumina particles of sub-micron sizes may be used with an average particle size, for example, of 0.1 μm and a mass-percent of 0.1-0.4. Additional examples include inorganic particles, aluminum oxide, magnesium oxide, and titanium oxide, such complex oxides as kaolin, talc, and montmorillonite, such carbonates as calcium carbonate and barium carbonate, such sulfates as calcium sulfate and barium sulfate, such titanates as barium titanate and potassium titanate, and such phosphates as tribasic calcium phosphate, dibasic calcium phosphate, and monobasic calcium phosphate. Two or more of these may be used together to achieve a specific objective. As examples of organic particles, vinyl materials as polystyrene, crosslinked polystyrene, crosslinked styrene-acrylic polymers, crosslinked acrylic polymers, crosslinked styrene-methacrylic polymers, and crosslinked methacrylic polymers, as well as such other materials as benzoguanamine formaldehyde, silicone, and polytetrafluoroethylene may be used or contemplated.

One way to incorporate the aforementioned antiblock particles is via masterbatch addition. In that embodiment, high crystalline polyester layer (a) is produced by extruding a pellet-to pellet mix of a crystalline polyester (major component) and a second polyester (minor component; masterbatch), which is loaded with the antiblock and/or slip additives.

The polyester resin layer (a) preferably includes 50 to 100 ppm of a conductive metal compound, comprising such as calcium (Ca), manganese (Mg) and/or magnesium (Mn). The conductive metal compound can be added during the polymerization process as a catalyst or additive, or during the extrusion process in a masterbatch form to secure enough conductivity for electric pinning in the film-making process. Less than 50 ppm of the metal compound may cause pinning issues, more than 100 ppm of the metal compound may degrade the hydrolysis and transparency performance.

Examples of manganese compounds that may be used include manganese chloride, manganese bromide, manganese nitrate, manganese carbonate, manganese acetylacetonate, manganese acetate tetrahydrate, and manganese acetate dihydrate. Examples of magnesium compounds that may be used include magnesium chlorides and carboxylates. Magnesium acetate is a particularly preferred compound. Example of calcium compounds that may be used is calcium acetate. Magnesium acetate is a particularly preferred compound.

Additional additives, for example, phosphorous (P)-based compounds, can be used to suppress coloring (yellowness) of the polyester and can be added in an amount of between 30 to 100 ppm. Less than 30 ppm may not sufficiently reduce undesirable coloring of the film, but more than 100 ppm may make the film hazier.

The phosphorus-based compound is preferably a phosphoric acid-based compound, a phosphorous acid-based compound, a phosphonic acid-based compound, a phosphinic acid-based compound, a phosphine oxide-based compound, a phosphonous acid-based compound, a phosphinous acid-based compound, or a phosphine-based compound from the standpoint of thermal stability, suppression of debris, and improving hue. Phosphoric acid-based and phosphonic acid-based compounds are particularly preferable.

Amorphous skin layer (b) can be coextruded on one side of the core layer (a), to a final thickness after biaxial orientation between 0.1 and 10 μm, preferably between 0.2 and 5 μm, and more preferably between 0.5 and 2.0 μm.

The amorphous sublayer b may contain an anti-blocking agent and/or slip additives for good machinability and a low coefficient of friction.

For the embodiments in which the biaxially oriented multilayer polyester is PET-based (for example, in one embodiment depicted in FIG. 1, the combination of layers (a) and (b); additional skin layer(s) may be present as mentioned previously), the coextrusion process includes a two- or three-layered compositing die. In general, a preferred extrusion process for producing the polyester film, masterbatch and crystallizable polyester feed particles are dried (preferably less than 100 ppm moisture content) fed to a melt processor, such as a mixing extruder. The molten material, including the additives, is extruded through a slot die at about 285° C. and quenched and electrostatically-pinned on a chill roll, whose temperature is about 20° C., in the form of a substantively amorphous prefilm. The film may then be reheated and stretched longitudinally and transversely; or transversely and longitudinally; or longitudinally, transversely, and again longitudinally and/or transversely. The first longitudinal stretching may also be carried out at the same time as the transverse stretching (simultaneous stretching). The preferred is sequential orientation of first longitudinally, then transversely. The stretching temperatures are generally above the glass transition temperature of the film polymer by about 10 to 60° C.; typical machine direction processing temperature is about 95° C. Preferably, the longitudinal stretching ratio is from 2 to 6, more preferably from 3 to 4.5. Typical transverse direction processing temperature about 110° C. Preferably, the transverse stretching ratio is from 2 to 5, more preferably from 3 to 4.5. Preferably, any second longitudinal or transverse stretching is carried out at a ratio of from 1.1 to 5. Heat setting of the film may follow at an oven temperature of about 180 to 260° C., preferably about 220 to 250° C., typically at 230° C., with a 5% relaxation to produce a thermally dimensionally stable film with minimal shrinkage. The film may then be cooled and wound up into roll form.

In polymer morphology orientation can involve alignment of the structural elements of the polymer, for example, polymer chains, segments of chains and crystallites. Orientation can cause anisotropic physical properties in a polymer product. For a polymer film, orientation can be induced by stretching the film. In this disclosure, the terms “orientation”, “orienting”, “oriented”, and the like are used occasionally, whether or not accompanied by alignment of polymeric structural elements, and are meant to be interchangeable with corresponding terms, “stretch”, “stretching”, “stretched” and etc. In most high volume, polymeric film production, the film is formed continuously by extrusion and elongation in which the direction of material flow is commonly known as the “machine direction”, Typically, the first technical direction is the machine direction and the second technical direction is the cross-machine or “transverse direction” (i.e., in the plane of the film at 90° to the machine direction.

According to this invention, film may be unoriented, uniaxially oriented or biaxially oriented. Uniaxially oriented means that the film is stretched only in a first technical direction. Biaxial orientation occurs when a uniaxially oriented film is stretched in a second technical direction transverse to the first technical direction. Biaxial orientation can be achieved by stretching the film in both directions, either sequentially or simultaneously. For sequential biaxial orientation, first technical direction stretching is completed before stretching in the second technical direction. In simultaneous biaxial orientation, both first and second direction stretching occur at or near the same time.

### The Polymeric Gas Barrier Layer (B)

The gas barrier layer (B) comprises modified polyvinyl amine (mPVA) and is disclosed in detail in U.S. Pat. No. 9,617,059. The mPVA is polyvinyl alcohol/polyvinyl amine copolymer crosslinked with citric acid and an optional additional crosslinking agent such as epichlorohydrin. The barrier layer can be applied by deposition of a reactive aqueous solution onto the base layer (A), heating and drying to remove water and crosslink the reactants. Excellent gas barrier properties of the film are obtained by applying and crosslinking the barrier layer during the transverse stretching steps of a biaxial oriented polymer film (base layer (A)) continuous fabrication process. Superior gas barrier properties are achieved with transverse stretching by a factor of about 3-4.

The gas barrier layer composition is a citric acid crosslinked polyvinyl amine. Citric acid has the formula HOOCCH2C(OH)(COOH)CH2COOH, a melting point of 153° C. and water solubility of 240 g/100 g H₂O at 25° C. A suitable example of acceptable citric acid is food grade, white, solid powder, water soluble pH 2.1, CAS No. 77-92-9 anhydrous citric acid available from Duda Energy, LLC (Decatur, Ala.). Having multiple potentially reactive carboxyl functional groups per molecule, citric acid is able to cross-link with the amine moiety present on the polyvinyl amine, as explained by the reactions described in greater detail below. Thus in connection with this invention, the terms “modification” and “modified polyvinyl amine” are sometimes referred to respectively herein as “crosslinked” and “crosslinked polyvinyl amine” and the like.

The polymeric component of the barrier layer crosslinked by citric acid is polyvinyl amine. Although expected to have good gas barrier properties when reacted with citric acid according to this invention, polyvinyl amine tends to become increasingly brittle and inflexible as the vinylamine content increases. Vinylamine homopolymer and vinylamine copolymers having large proportions of vinylamine are thus less preferred for use in the barrier layer especially in packaging film utilities. The barrier layers produced from such high vinylamine content polymer frequently craze, crack, and delaminate from the substrate during movement occurring in many end use applications. This behavior can render the gas barrier ineffective and impracticable.

Copolymers of polyvinyl amine that have good film-forming, flexural and pliant mechanical properties are particularly suitable for use in this invention. Preference is given to polyvinyl alcohol/polyvinyl amine (PVOH/PVA) copolymer. Preferably polyvinyl amine content of the PVOH/PVA should be less than about 25 mole %, more preferably less than about 20 mole %, and most preferably less than about 18 mole %. To provide desirable moisture vapor and oxygen gas barrier performance in packaging or balloon films, PVOH/PVA of the barrier layer should contain at least about 5 mole % polyvinyl amine, preferably at least about 8 mole % and more preferably at least about 10 mole %.

Water-soluble vinyl amine polymer is preferred. A representative example of vinyl amine polymer suitable for use in this invention is Ultiloc® 5003 BRS (available from Sekisui Specialty Chemicals America, LLC) PVOH/PVA copolymer. It is a nominal 12 mol % vinylamine/88 mol % vinyl alcohol copolymer with an amine content of about 2.3-2.6 meq NH₂/gram, a weight average molecular weight of about 10,000-20,000, a viscosity at 20° C. in 4% aqueous solution of about 5-10 cps, (0.005-0.010 Pa·s) a pH in 4% aqueous solution of about 9-12, a glass transition temperature “Tg” for the powder of about 85-100° C., and a melting point for the powder of about 180-220° C. Ultiloc® 5003BRS can be readily dissolved in water up to about 20 wt % non-volatile solids. The term “non-volatile solids (“NVS”) refers to the dry concentration of components that may be provided as a liquid or in a liquid medium (such as solid components suspended or dissolved in a liquid) after the liquid is removed by evaporation.

In the barrier layer of this invention the vinyl amine polymer can be crosslinked with an optional crosslinking agent in addition to citric acid. Representative crosslinking agents that are useful for crosslinking vinyl amine polymer in accord with this invention include the following: melamine-based cross-linker, epoxy-based cross-linker, aziridine-based cross-linker, epoxyamide compounds, titanate-based coupling agents (e.g., titanium chelate), oxazoline-based cross-linker, isocyanate-based cross-linker, methylolurea or alkylolurea-based, aldehyde-based, and acrylamide. Preferred additional crosslinking agents are glyoxal and epichlorohydrin.

The precise mechanism by which citric acid modifies vinyl amine polymer to enable achieving the beneficial results of this invention is not presently well understood. Without committing to a particular theory, it is contemplated that using citric acid alone or together with an optional additional crosslinking agent, aids in the formation of the crosslinked vinyl amine polymer network having reduced free volume within the polymeric matrix. This may allow the coating to stretch up to about eight to ten times the original coating dimension without forming barrier layer discontinuities and thus provide improved gas barrier performance.

The polymeric barrier layer (B) is applied on the base film (A) by a coating process. One aspect of this process relates to formation of a solution that can be coated onto the polymeric base layer as a precursor to a gas barrier layer. The solution includes vinyl amine polymer particles and citric acid particles dissolved in a solvent. The preferred solvent is water. Polar co-solvents with water such as methanol, ethanol, propanol, and mixtures thereof can optionally be used. Preferably cosolvents have volatility sufficiently high to enable rapid evaporation from solution coated film at temperature of at least about 100° C. The amount of solvent is selected to be suitable to completely dissolve all solid components of the solution. Solutions typically have a concentration in the range of about 3-30 wt % total non-volatile solids (“NVS”) content, preferably about 10-20 wt %, and more preferably about 12-16 wt %. Concentration of solute in solution can affect solution viscosity. The higher the concentration of non-volatile solids, the more cost-effective the coating becomes as less water needs to be driven off. However, higher solids content increases solution viscosity. If solids content is too high, the solution can be too viscous to easily handle and apply in substrate coating operations. Viscosity of the coating solution is preferably less than about 200 cps (0.20 Pa·s), and more preferably about 100-200 cps (0.10-0.20 Pa·s). The coating solution may also be heated or warmed to ca. 100-140° F. (ca. 38-60° C.), preferably 120° F. (ca. 49° C.), to aid in lowering the viscosity to the preferred range.

Great preference is given to first substantially completely dissolving the citric acid particles prior to charging and dissolving vinyl amine polymer, in particular PVOH/PVA particles in the solution. Although it is intuitive that vinyl amine polymer particles and citric acid particles could be dissolved in any order or together, it is understood that adding vinyl amine polymer after citric acid is dissolved provides better (i.e., lower) coating solution viscosity, shear stability, solution storage stability and superior gas barrier properties in the ultimately formed barrier film. The mixtures of vinyl amine polymer, citric acid and water can be heated to increase the rate of dissolution. Typical dissolving temperature is in the range of about 85° C.-100° C. Dissolving is also usually facilitated by moderate agitation of the mixture and normally is completed within about 15-60 minutes.

The amount of citric acid depends mainly on the quantity of PVA polymer in solution. The citric acid should be present to provide carboxylic acid functional groups at least stoichiometrically equal to the reactive amine in the vinyl amine polymer. Preferably acid:amine weight ratio should be in the range from about 0.1:1 to about 0.3:1, more preferably from about 0.13:1 to about 0.17:1 and most preferably about 0.15:1.

A process parameter for effectively controlling the proper proportion of citric acid to PVOH/PVA copolymer is pH of the liquid aqueous coating solution. A typical aqueous solution of about 14 wt % PVOH/PVA has a pH of about 11-12. Adding citric acid to solution lowers the pH. Generally, the more citric acid, the lower pH of solution and the greater extent of crosslinking of PVOH/PVA can be expected. A significant amount of citric acid crosslinking of the PVOH/PVA is desirable to achieve enhanced oxygen barrier properties in the barrier layer.

Additional solvent-miscible liquid and solvent-soluble, solid components optionally can be added and dissolved in the coating liquid aqueous solutions. Usually these added components are present in small proportions relative to vinyl amine polymer and citric acid. For example, methanol and Dowanol™ DPM dipropylene glycol methyl ether (The Dow Chemical Company) may be added. DPM can be incorporated in the aqueous barrier layer precursor solution at about 2-20 wt %, and preferably about 10-15 wt %, of the NVS components in the solution. These materials are included to improve the wetting performance of the solution on the surface of the substrate polymeric film for more uniform and complete liquid coating and barrier layer formation.

Another important aspect of preferred embodiments of this invention relates to forming the polymeric base layer, coating the barrier layer precursor solution on a surface of the base layer, and post-coat treating the film. Post-coat treatment includes removing volatile liquid of solution and crosslinking the vinyl amine polymer with citric acid, optionally with additional crosslinking agent, to form a composite of dry, solid barrier layer adhered to the base layer, stretching the composite film and further optionally heat-treating the composite film. Preferably according to this invention, base layer formation, barrier layer solution coating and post-coat treatment are carried out in a continuous, integrated series of steps. In effect, the crosslinking can occur during drying and stretching in the tentering oven of a film orientation machine.

Thus it is quite advantageous to make the novel barrier packaging film composite in existing commercial continuous, biaxially oriented film production units equipped with an in-line liquid coating station with slight operating adjustments. This is accomplished by depositing the liquid barrier layer coating solution onto a base layer film directly after machine direction stretching, and then heating the solution-coated base layer while stretching the film in the transverse direction in a tenter frame oven for a residence time as recited above effective to react citric acid with the polyvinyl amine and to evaporatively remove substantially all of the liquid of solution. Generally, the solution-coated base layer film is heated to 90° C.-185° C. Due to their physical properties, some process conditions for different base layer polymers can be different. Polyester base layer films are preferably heated to about 90-121° C. and stretched in the transverse direction by a stretch factor of about 3-4. Polyolefin base layer films are preferably heated to about 150-180° C. and stretched by a stretch factor of about 8-10.

It is also preferable to “anneal” (also known as “heat-setting”) the film at appropriate temperatures after stretching in order to minimize shrinkage of the composite film and to provide a dimensionally and thermally stable film. Annealing can be performed in the tenter frame oven. Typically a tenter frame oven has multiple heating zones that can be controlled at different temperatures. The annealing usually occurs in heating zones that follow heated stretching zones in the oven. Heat shrinkage of the composite film after orientation is determined substantially according to ASTM D1204. For composite film with a polypropylene base layer shrinkage determination conditions are 284° F. (140° C.) for 15 minutes. For composite film with a polyethylene terephthalate base layer, shrinkage determination conditions are 300° F. (150° C.) for 30 minutes. Preferably, heat shrinkage of the composite films should be less than about 10% for polyolefin and less than about 5% for polyester in the respective longitudinal and transverse directions of the oriented composite film.
This invention is deemed suitable for implementation by two basic types of process methods for applying the barrier coating layer, namely, “offline” and “inline” methods. The procedures for film stretching and applying the barrier layer coating solution distinguish these methods as will be explained.

In an “off-line” method the base layer film (A) is formed completely and then wet barrier layer coating solution is applied to the completed base layer. The barrier layer solution can be applied to a uniaxially stretched base layer, but typically the base layer is biaxially stretched. Commonly, although not necessarily, the steps of base layer film forming and barrier layer solution coating are performed discontinuously from each other. That is, the base layer film can be produced, stretched and held in storage for coating at a later time and usually at a different location.

After production of the base layer, it is subjected to coating with the barrier layer liquid solution. Various solution coating methods well known in the art may be used. Representative examples include dip, spray, paint, doctor, gravure roll, and Mayer (sometimes referred to as “Meyer”) rod type techniques. Preferably a Mayer rod coater with a No. 2 or No. 4 Mayer rod can be used; more preferably, a gravure roll method is used. It is also sometimes helpful to ion discharge-treat the coating receiving side of the base layer prior to coating to improve adhesion of the barrier layer and/or to wet-out (i.e., uniformly spread) the coating liquid onto the base layer surface. Such discharge-treatment methods are well-known in the art as corona treatment, flame treatment, plasma treatment, atmospheric plasma treatment, or corona treatment in a controlled atmosphere.

After coating the base layer surface with barrier layer liquid solution, a solidified barrier layer is formed by heating and drying the wet base layer, typically in a zoned drying oven or tunnel. The heat both dries the barrier layer by evaporating volatile liquid components and causes reactive components to crosslink the residual vinyl amine polymer of the liquid solution. Off-line coating separate from base layer film formation can be carried out in a continuous film coating operation.

Drying temperatures in an offline coating process can affect the gas barrier properties. A potential problem of drying at too low a temperature is that the heat energy transmitted to the film is not sufficient to fully activate the cross linking of the mPVA. Thus to make a composite barrier film with effective moisture and oxygen resistance by the off-line method, attention must be given to balancing temperature and residence time conditions in the drying oven.

The inline production method is a preferred embodiment of the invention. Basically, in this process, the base layer (A) is extruded and formed as previously described, coated with liquid barrier layer (B) solution, and heated to dry and crosslink the vinyl amine polymer in a unified and continuous process. According to other preferred embodiments, additional steps can be included, for example the base layer can be uniaxially stretched before coating with liquid solution. Also the barrier layer can be dried, crosslinked and stretched at the same time or in rapid succession after coating with the base layer. Still further, the composite barrier film can be heat-treated to anneal the film after the barrier layer is formed.

A major advantage of the inline method is that time and temperature of heat exposure during solution drying can be controlled very well. This permits higher temperatures to be used for appropriately short times. Consequently, the barrier layer solution can be dried with effectively complete crosslinking of the vinyl amine polymer with reduced risk of damaging the film. Also, in the inline process, drying and crosslinking can be accomplished at or very near the same time as stretching the base layer in at least one direction. It has been found that such contemporaneous drying, crosslinking and stretching can significantly further improve gas transmission resistance performance. Thus a particularly preferred embodiment of inline process includes the continuous, sequential steps of (1) forming a polymer core layer, (2) optionally adding an adhesive layer and/or a skin layer to make the base layer, (3) stretching the base layer, preferably uniaxially in the machine direction, (4) coating the base layer with liquid solution of vinyl amine polymer and citric acid, (5) heating the coated base layer effectively to dry and crosslink the vinyl amine polymer to form an mPVA barrier layer, (6) optionally stretching the composite barrier film in the transverse direction during or immediately following the drying and crosslinking step, and (7) optionally heat treating to anneal the composite barrier film. When present as a component of the base layer, step (4) coating is applied to the surface of an optional adhesive layer to promote good adhesion of the coating to the base layer.

More fully explained, the inline method includes extruding a sheet of polymer from granulated solid form such as pellets in a melt processing apparatus. Continuously following extrusion, the sheet is stretched in the first technical direction, usually the machine direction. The solution coating apparatus is positioned directly after the base layer is formed and uniaxially stretched. Liquid coating solution is applied while the base layer moves continuously through the coating apparatus application station. The same solution coating technologies described above for off-line coating may be used for placing the wet coat of barrier layer solution on the polymer base layer. For the inline method, reverse gravure roll coating techniques are preferred.

Directly and continuously following liquid solution coating of the base layer, drying, crosslinking and preferably biaxial stretching steps are performed in rapid succession. In-line fabrication can use the same composite barrier film finishing methods as described for “off-line”, but instead of using a static oven, the film is continuously fed through a tenter frame stretching oven. The tenter frame stretching oven has several heating zones so that different segments of the process can be at temperatures tailored to accomplish each unit function. For example, the wet coating volatiles can be substantially completely removed to form a dry unitary barrier layer adhered to the substrate surface in preheating and drying heat oven zones. Then temperature can be adjusted to a range adapted to activating crosslinking of the vinyl amine polymer by citric acid and to biaxial stretching of the composite barrier film. Preferably the barrier layer is fully dried before crosslinking and biaxial stretching. As an example, in a nominal 1.5 m wide tenter frame stretching oven, a film machine direction travel speed of about 80 ft/min (24 m/min), typical crosslinking and biaxial stretching zone temperatures of the inline method are in the range of 155-160° C. for polypropylene base layer film, and in the range of about 90-121° C. for polyethylene terephthalate base layer film. These operating temperatures are much higher than should be used in the off-line method. Higher temperature can be tolerated during inline processing because the flow of film is continuous through the heat zones and time and temperature exposure can be controlled to avoid damaging the film. In another embodiment, some or all of the liquid solvent removal occurs and the barrier layer is crosslinked with citric acid and optional crosslinking agent during oven heating while conducting transverse stretching. After transverse stretching, the film can be heat-set to minimize shrinkage.

It has been discovered that the citric acid crosslinked mPVA barrier layer can be stretched to large transverse extensions while remaining intact and maintaining good barrier properties over the full surface of the multilayer film. This performance is predominantly observed when the wet coating solution is applied to an already uniaxially stretched base layer, and the barrier layer is contemporaneously dried, crosslinked and biaxially stretched This occurs in both mPVA crosslinked by citric acid with or without an optional supplemental crosslinking agent, such as epichlorohydrin. The barrier layer has been found to successfully extend to about 3-4.5 times its original transverse dimension, (i.e., 3×-4.5×) which is a property suitable for lower extension substrate materials such as polyesters. It is also able to extend to as much as 8 times original transverse dimension (i.e., 8×-10×) that is useful for higher extension capable substrate materials such as polyolefins, especially polypropylene base layer films.

In addition to the basic components of substrate polymer and PVOH/PVA, citric acid, crosslinking agent and solvent of the barrier layer, other materials may be present in the liquid coating solution. These other materials facilitate the preparation, processing and coating of the solution, processing the base layer formation or product film handling. These materials are usually incorporated in small proportions relative to the basic components and do not substantially change the gas barrier properties of the invention.

Such other materials that can be optionally utilized in carrying out this invention include preservatives or biocides for maintaining freshness of the coating solution during storage. A representative example is Ultra-Fresh® SAB40 (also known as Bioban® bp-40 available from Dow Chemical Company).

### The Sealant Layer (C)

A preferred embodiment in a balloon laminate construction is the inclusion of a polyolefin layer, which provides the low-melt temperature seal layer necessary for forming the balloon. Preferably the polyolefin comprises linear low density polyethylene (LLDPE).

Sealant layer (C) may be hot melt-extruded as an extrusion coating onto the anchor layer (D). The sealant layer (C) may be a grade of Low Density Polyethylene (LDPE), Linear Low Density Polyethylene (LLDPE) or a blend of Low Density Polyethylene and Linear Low Density Polyethylene. A typical material for the sealant layer is Dowlex® 3010 LLDPE resin from Dow. The temperature of the LLDPE melt may be from 305 to 325° C., with a higher temperature being preferable for melting of the skin layer (b) to promote bonding. The LLDPE melt layer may then be chilled to form sealant layer (C) with a thickness of from 10 to 20 μm.

Another method for applying the sealant layer (C) is to use an adhesive to laminate a pre-formed Low Density Polyethylene sheet to the skin layer (b). Suitable adhesives include, but are not limited to, polyester, polyester urethane, polyether urethane, and acrylic chemistries. Adhesive thickness may be from 1 to 6 μm thick. The thickness of pre-formed low density polyethylene sealant sheet may range from 10 to 100 μm, preferably using thinner sealant sheet from 10-30 μm for smaller volume balloons, less than 11 ft3, to maintain buoyancy in air.

### The Anchor Layer (D)

In some embodiments, a primer layer can be applied to one side of the base film. In some embodiments, the primer layer can be added by a solution coating method, such as gravure roll coating. The anchor layer (D), also referred to as the primer, may be selected from, but not limited to, a polyethylene dispersion, particularly polyethylenimine. Other anchor materials include ethylene acrylic acid copolymer, ethylene methyl acrylate or urethane. Anchor layer (D) may be applied in dispersion in water or another solvent, using an application method such as gravure coating, Meyer rod coating, slot die, knife over roll, or any variation of roll coating well known in the art. The applied dispersion may then be dried with hot air, leaving a layer approximately 0.01 to 0.1 μm thick. In some embodiments, the dry coat weight of the primer layer can be up to about 0.03 pounds per ream. In some embodiments, the dry coat weight of the primer layer can be about 0.005-0.02, about 0.0075-0.015, about 0.0075-0.0125, or about 0.01 pounds per ream. The primer layer can be between the base film (A) and the (extrusion-coated) heat seal structure (C) to help ensure strong adhesion of the heat seal structure to the base film. In some embodiments, the primer layer can be formed using MICA A-131-X. The skin layer (b) may be discharge-treated prior to application of the anchor layer (D). The discharge-treatment is used to increase the surface energy of the skin layer (b) to increase wetting of the dispersion and bond strength of the dried anchor layer (D. Treatment methods include corona, gas modified corona, atmospheric plasma, and flame treatment.

### The Embossed Coating Layer (E)

In one embodiment the embossable coating (E) may be a thermo-sensitive material such as polyethylene, polystyrene, acrylic, polyurethane, polyvinyl chloride and styrene butadiene like thermoplastics or semi-cured thermosets which have discernible thermoplastic properties. Such a process for applying an embossable coating is described. For example, an embossable coating comprising a polyester or a polyester-acrylic resin can be applied to one side of the polyester (PET) base film using an offline or inline coating process (usually offline), the film being coated from an aqueous solution with a non-crosslinked polystyrene-acrylic emulsion or a non-crosslinked polyester dispersion or a mixture thereof, the Tg of the coating resin being greater than about 20° C., preferably greater than about 35° C., and less than about 70° C., the embossable coating resin being capable of impregnating a surface of the polymeric gas barrier layer (B) under heat and pressure. This is followed by embossing the exposed surface of the embossing material layer opposite the polymeric barrier layer (B) in which the embossed surface defines a diffraction grating pattern.

An example of an acrylic copolymer-based embossing material composition coating liquid formulation includes 49% Setaqua™ 6472 acrylic copolymer emulsion (Nuplex Resins, LLC, Louisville, Ky.), 2% Dowanol® PPH (Dow Chemical Co., Midland, Mich.), 0.5% Chemslip® 25 wax, (ChemCor, Chester, N.Y.), and 0.2% Surfynol® 440 surfactant (Air Products and Chemical, Inc., Allentown, Pa.). The acrylic copolymer in Setaqua™ 6472 is a thermoplastic with a glass transition temperature (“Tg”) of 40° C. Dowanol® PPH is a coalescent glycol ether serving as a temporary plasticizer. Chemslip® 25 is a synthetic wax emulsion used here as an embossing shim release aid. Surfynol® 440 surfactant is a 100% active liquid, ethoxylated wetting agent and defoamer serving here to reduce the surface tension of the liquid embossing material composition which aids in the wetting of the solution to the substrate.

Examples of aliphatic polyurethane embossing materials include Solucote® 1051i-2-25, from DSM Neoresins, a 35% solids aqueous dispersion also including 5% Surfynol® 420 as surfactant. Another polyurethane example is DSM Neoresins Solucote® 1372, an aliphatic polyurethane dispersion with no surfactants.

Other examples include Eastek® 1000 6 wt. % solids aqueous amorphous sulfopolyester dispersion sold by Lawter, Inc.; Paracryl® 8340 or 8227, 10% solids styrene-acrylic emulsions sold by Parachem, Incorporated;

In embodiments, it is also advantageous to employ an adhesion promoter to obtain further enhanced adhesion between the polymeric barrier layer film (B) and the embossable coating (E). One particularly advantageous type of adhesion promoter is a polyfunctional aziridine, preferably “Xama 7” sold by Sybron, Inc. Of course, other adhesion promoters may be utilized in accordance with the invention.

### The Metal Deposition Layer (F)

A thin layer of metal (F) is deposited onto the textured surface of the embossed layer (E) to form a metal layer such that the metal layer conforms to the textured surface, thus also exhibiting the desired textured surface. In a preferred embodiment the embossing step produces a pattern of diffraction grating lines. Thus light impinging on the outer surface of the embossing material layer (E) will be diffracted when reflected from the metal layer (F), thereby producing a holographic style effect.

Suitable metal layer materials used herein include Al, Au, Ag, Cu, Pt, Ni, Ti, Ta and mixtures thereof. The metal layer is generally at a thickness of about 20-50 nm. Many thin film metal deposition techniques can be used that are well-known in the art, such as chemical vapor deposition, sputtering, high speed vapor deposition, and the like.

The metal layer is preferably applied by vacuum deposition. The unmetallized embossed laminate sheet is first wound in a roll. The roll is placed in a metalizing vacuum chamber and before deposition of the aluminum layer, a plasma treatment process is preferably used to clean and functionalize the embossed surface layer. The utilization of the plasma treatment produces very high metal adhesion and it is believed that it also increases the surface energy of the resultant metal surface. It is believed that both attributes are desired in combination in order to give commercial utility to the disclosed products/devices. In addition to plasma treatment processing, other surface treatment methods may be employed in the vacuum system. Included in the alternative methods are copper seeding, nickel seeding or other sputtering treatment methodologies.

The metal film may include titanium, vanadium, chromium, manganese, iron, cobalt, nickel, copper, zinc, aluminum, gold, or palladium, the preferred being aluminum. Metal oxides can also be contemplated, the preferred being aluminum oxide. The metal layer shall have a thickness between 5 and 100 nm, preferably between 20 and 80 nm, more preferably between 30 and 60 nm; and an optical density between 1.0 and 5.0, preferably between 2.0 and 4.0, more preferably between 2.3 and 3.2.

The combination of the metallized layer (F) and the polymeric barrier layer (B) creates a very high gas barrier property that can further improve the life time of a balloon.

Once the laminations are prepared, the following process may be used to fabricate the balloons: 1) flexographic printing of graphic designs on the metalized embossed surface, 2) slitting of the subsequent printed web, 3) fabrication of balloons by die-cutting and heat sealing process, and 4) folding and packaging of the finished balloons.

Flexographic printing may be used to print graphic designs on the balloons. The printing equipment used in this process may be set up in a manner that will prevent scratching, scuffing or abrading the gas barrier surface. The side of the gas barrier layer (B) opposite the base film layer (A) of the laminate may be printed with up to 10 colors of ink using a flexographic printing press prior to applying the embossing layer (E). Each ink color receives some drying prior to application of the subsequent color. After print application, the inks may be fully dried in a roller convective oven to remove all solvents from the ink. The embossable layer (E) may then be applied on top of the printed surface. This can also help protect the printed surface from scuffing or abrasion.

Slitting may be accomplished in any suitable fashion. The slitting equipment used in this process is desirably set up in a manner that will prevent scratching, scuffing or abrading the gas barrier surface. In one embodiment, the printed web may be cut to lengths adequate for the balloon fabrication process by rewinding on a center driven rewinder/slitter using lay-on nip rolls to control air entrapment of the rewound roll.

Balloon fabrication may be accomplished in any suitable fashion. The fabrication equipment used in this process is desirably set up in a manner that will prevent scratching, scuffing or abrading the gas barrier surface. The slit webs may be fabricated into balloons by aligning two or more webs into position so that the printed graphics are properly registered to each other, then are adhered to each other and cut into shapes using known methods. A seam thickness of 1/64″ to ½″ may be used, as this seam thickness has been found to have greater resistance to defects with an optimal seam being 1/16″ to ⅛″. Optionally, a valve can be inserted into an opening and the layers abutting the valve adhered to form a complete structure.

Folding may be accomplished in any suitable fashion. The folding equipment used in this process is desirably set up in a manner that will prevent scratching, scuffing or abrading the gas barrier surface. The fabricated balloons may be mechanically folded along multiple axes using much different mechanical process or by hand. The balloon can be folded to the proper size mechanically and then mechanically or by hand loaded into a pouch. The balloon can also be hand-folded along multiple axes with care taken not to scratch, scuff or abrade the metalized surface. The hand-folded balloon can also be inserted into a pouch by hand or mechanically.

### EXAMPLES

The following Examples are being submitted to further define various species of the present disclosure. These Examples are intended to be illustrative only and are not intended to limit the scope of the present disclosure. Also, parts and percentages are by weight unless otherwise indicated.

### Crystalline Polyesters

PET resin (“PET-1”): film-grade crystalline PET resin Lumirror® F21MP (IV=0.65 dL/g; Tm=255° C.) manufactured by Toray Plastics (America), Inc.

PET resin (“PET-2”): crystalline PET resin (IV=0.62 dL/g; Tm=255° C.) anti-block masterbatch, containing about 2.0 wt % Silysia® YS-2 (Yugenkaisha Y.K.F. Corporation, Japan) manufactured by Toray Plastics (America), Inc. under grade name Lumirror® F118.

Next, 95 parts by weight of polyester pellets (PET-1), 5 parts by weight of polyester pellets (PET-2) were mixed. The mixed pellets were extruded to produce melt stream for core layer (a).

### Copolyester Resin “IPET”

An amorphous co-extruded surface layer (b) for the polyester thermoplastic film (A) was prepared as follows. An isophthalic acid co-terephthalic acid random copolyester co-polymer with an IV of about 0.65 and a mol ratio of about 18% isophthalic acid and 82% terephthalic acid, was prepared using generally similar procedure as that described above for crystalline polyester layer (a). Alternatively, a copolyester consisting of a random co-polymer of cyclohexane dimethanol residues, commercially available from Eastman Chemical, with an IV of about 0.70 can be utilized as the amorphous layer.

### Test Methods

The various properties in the examples were measured by the following methods:

Intrinsic viscosity (IV) of the film and resin were tested according to ASTM D 460. This test method is for the IV determination of poly(ethylene terephthalate) (PET) soluble at 0.50% concentration in a 60/40 phenol/1,1,2,2-tetrachloroethane solution by means of a glass capillary viscometer.

Melting point of polyester resin is measured using a TA Instruments Differential Scanning calorimeter 2920. A 0.007 g resin sample is tested, using ASTM D3418-03. The preliminary thermal cycle is not used, consistent with Note 6 of the ASTM Standard. The sample is then heated up to 280° C. temperature at a rate of 10° C./minute, then cooled back to room temperature while heat flow and temperature data are recorded. The melting point is reported as the temperature at the endothermic peak located in the temperature range between of 150 and 280° C.

Optical Density of the metallized film is measured using a Gretag D200-II measurement device. The device is zeroed by taking a measurement without a sample in place. Then the optical density of the polyester film layers and metallic gas barrier layer is measured every 3″ across the web and the average is reported as the metal OD. Optical density is defined as the amount of light transmitted through the test specimen under specific conditions. Optical density is reported in terms of a logarithmic conversion. For example, a density of 0.00 indicates that 100% of the light falling on the sample is being transmitted. A density of 1.00 indicates that 10% of the light is being transmitted; 2.00 is equivalent to 1%, etc.

Wetting tension of the surfaces of interest was measured substantially in accordance with ASTM D2578-67. In general, the preferred value was an average value equal to or more than 40 dyne/cm with a minimum of 36 dyne/cm.

Oxygen gas transmission rate (OTR) was measured with a Mocon Ox-tran® 2/20 Oxygen Permeability Testing Apparatus (Mocon Inc., Minneapolis Minn.) substantially in accordance with ASTM D3985. Testing conditions used were 73° F., 0% relative humidity, and 1 atm. Preferred OTR ranged from 0.005-0.2 cc/100 in2/day (0.08-3.1 cc/m2/day).

Moisture vapor transmission rate (MVTR) of film was measured with a Permatran® 3/31 Water Vapor Transmission Rate Testing Device (Mocon Inc., Minneapolis Minn.) substantially in accordance with ASTM F1249. Preferred MVTR ranged from 0.05-0.13 g/100 in2/day (0.8-2.0 g/m2/day).

Floating time of the balloon is determined by inflating it with helium gas and measuring the number of days that the balloon remains fully inflated. A balloon is filled from a helium source using a pressure regulated nozzle designed for “foil” balloons, such as the Corwin Precision Plus balloon inflation regulator and nozzle. The pressure should be regulated to 16 inches of water column. The balloon should be filled with helium in ambient conditions of about 20° C. temperature and 1 atmosphere barometric pressure. The balloon should be secured using adhesive tape on the outside of the balloon below the balloon's valve access hole to avoid creating any slow leaks of helium gas through the valve. During the testing the balloon should be kept in stable environment close the ambient conditions stated. Changes in temperature and barometric pressure should be recorded to interpret float time results, as any major fluctuations can invalidate the test. The balloon is judged to be no longer fully inflated when the appearance of the balloon changes so that the wrinkles running through the heat seal seam area become deeper and longer, extending into the front face of the balloon; and the cross-section of seam becomes a v-shape, as opposed to the rounded shape that characterizes a fully inflated balloon. At this time the balloon will still physically float, but will no longer have an aesthetically pleasing appearance. The number of days between initial inflation and the loss of aesthetic appearance described above is reported as the floating time of the balloon. Preferred float times were greater than 7 days, more preferably, 10 days or more.

### Example 1

### Preparation of Polyethylene Terephthalate Base Layer (A)

A 36 G (9 μm) two-layer polyester film (A) was prepared by co-extruding a skin layer (b) of aforementioned amorphous copolyester (“IPET)” adjacent to one side of a core layer (a), at a skin/core weight ratio of 5%. The extruded film was cast onto a cooling drum of surface temperature at about 21° C. moving at a linear speed of about 32 m/min. The film was oriented in the machine direction through a series of heated and differentially sped rolls by extending in the longitudinal direction at about 125° C. at a stretching factor of about 4.8 times the original length followed by annealing at about 100° C. to obtain a uniaxially oriented film

### Preparation of Polymeric Barrier Layer (B)

Aqueous liquid coating solutions were prepared. The liquid coating solutions were applied to uniformly coat the surface of the uniaxially oriented base layer. The water solvent of solution was removed by heating the wet-coated base layer. When citric acid and/or additional crosslinking agent were present in the coating solution, crosslinking of the barrier layer composition also was accomplished during solvent removal. The barrier layer was coated onto the core layer side (a) of the base layer (A). For biaxially oriented film examples, the coated uniaxially oriented base layer was stretched in the transverse direction (TD) in a tenter oven unit operation (“stenter”). The base layer polymer of the resulting biaxially oriented composite packaging film was heat set following TD stretching.

### Preparation of Barrier Layer Coating Solutions

The precise formulation of the coating (“dry weight” basis) was as follows:

| Coating Component | wt. % | Trademark and Supplier |
|---|---|---|
| PVOH/PVA (Copolymer | 84.63 | Selvol ™ Ultiloc ™ 5003 BRS |
| made from 88 mole %/ | | (Sekisui Specialty Chemicals of |
| vinyl alcohol | | America, Dallas, TX) |
| and 12 mole % vinyl | | |
| amine) | | |
| Defoamer/Surfactant | 0.71 | Surfynol ® 420 |
| | | antifoam/leveling surfactant |
| | | (Air Products and Chemicals, Inc.) |
| Epichlorydrin | 0.85 | Polycup ® epichlorydrin (Hercules, Inc.) |
| Citric acid | 13.82 | Duda Energy, LLC (Decatur, Ala.) |

The above formulation was applied as water-based liquid coating solution at a concentration about 16 wt. % of the sum of the above ingredients in deionized water.

Deposition of the liquid coating solution and subsequent treatment of the composite film can be performed in either an “inline” or an “offline” process. The inline process placed the polymeric barrier layer liquid coating solution onto the base layer immediately following the uniaxial orientation step in a continuous train of integrated process steps as described previously. The barrier layer (B) was placed on the core layer side (a) of the base layer (A).

For inline barrier coating of the examples, the exposed surface of the uniaxially oriented base layer (A) was corona discharge-treated prior to applying the barrier coating. Liquid solution of barrier layer (B) composition was then continuously coated onto the treated surface of the core layer (a) with a gravure roll of engraved cells of 22 BCM (billion cubic microns) volume. The barrier layer solution-coated film was then fed at a line speed of about 152 m/min. into a tenter oven having three heat zones and a cooling zone. First, second and third heat zones were maintained at about 118-127° C., 117-157° C. and 207-227° C., respectively. The first zone preheated and dried the coated barrier layer. In the second zone, the coated barrier layer was stretched in the transverse direction about 4.2 times its initial transverse direction dimension. The composite barrier film was heat-set/annealed in the third zone as appropriate to reduce internal stress caused by stretch-orientation and to minimize shrinkage, thereby providing a thermally stable biaxially oriented, crosslinked barrier, composite barrier film. The fourth segment of stenter provided a cooling zone where the film temperature was reduced down to 120° C. before exiting the stenter.

The composite barrier film was wound into a roll for further processing. This precursor laminate is designated in FIG. 1 by number 11. Nominal dimensions of the finished film 11 were: about 36 G (ca. 9 μm) overall thickness, about 5 G (1 μm) skin layer (b) thickness, 31 G (ca. 7.8 μm) core layer (a) thickness, and about 1 G (0.25 μm), equivalent to about 0.20 lb/ream (0.325 grams per m²) thickness of the dried and crosslinked barrier layer (B). The oxygen transmission rate (OTR) measured was 0.008 cm³/100 in²/day (0.12 cm³/m²/day). The moisture vapor transmission rate measured was 0.120 g/100 in²/day (1.86 g/m²/day). It is noted that these exemplary films including barrier layer coating were capable of transverse stretching up to 4.5 times its original transverse dimension.

During the inline coating and TD stretching unit operations to form the biaxially oriented polyethylene terephthalate base layer films, the temperature and duration of exposure conditions for each film, respectively, were effective to vaporize the volatile components of the liquid barrier coating solution. This produced a uniform and continuous solid polymeric barrier layer affixed to the base layer. In the example representing operative embodiments of this invention in which PVOH/PVA and citric acid were present, the conditions of TD stretching were effective to also cause amine-acid reaction as well as additional crosslinking when optional crosslinking agent was present.

### Application of Sealant Layer C by Means of Anchor Layer D

The wound roll of composite film 11 was taken to an offline extrusion coating line for application of the sealant layer (C). The surface of the coated base film (A) opposite to the polymeric barrier layer (B) (i.e. the amorphous skin layer (b)) was corona-treated and coated with anchor coating (D) solution (Mica A-131-X) using a gravure coater. The anchor (D) was dried in a convective dryer. The dried anchor surface was then extrusion coated with LLDPE sealant (layer (C)) (Dowlex® 3010, 13.6 μm thick), at a temperature of 315° C.

After the extrusion coating process, the film laminate at the end of this step is wound on a roll and transported to a different processing location for further treatment. The film laminate at the end of this step in the manufacturer process is represented in FIG. 1 by composite number 12.

### Application of Embossable Layer, Embossing and Metalization

An embossable coating was applied on the exposed barrier layer side (B) of composite 12 and embossing was conducted by a shim roll decorated with holographic engraving. Any type of embossable material, selected from those described previously or other could have been used. This invention is not limited by the type of embossable material being applied.

Subsequently, the embossed composite film was wound up and sent to the metalizing chamber. The embossed surface was metalized with aluminum to an optical density between 2.3 and 3.2. The resulting final balloon film 1 (in FIG. 1) had excellent holographic embossed appearance.

The extrusion coated film could also be optionally printed on the barrier surface (B) with up to 10 colors of ink, using a flexographic printing press, prior to application of the embossing layer (E). After print application, the inks were fully dried in a roller convective oven to remove solvents from the ink. The printed composite film could then undergo the processes of embossing and metallization as described previously. The finished composite film 1 was cut to lengths adequate for the balloon fabrication process by rewinding on a centre driven rewinder/slitter using lay-on nip rolls to control air entrapment of the rewound roll.

### Balloon Fabrication

The slit films were fabricated into balloons by aligning 2 or more slit films into position so that the embossed patterns and printed graphics were properly registered to each other, then adhered to each other by heat sealing (about 400° F. and 1 second) and cut into circle shape (17″ diameter). The seam of the balloons was ⅛″. A valve, as described in U.S. Pat. No. 4,917,646 was inserted into an opening and the layers abutting the valve adhered to form a complete structure. The balloon float life was tested and found to be in excess of 20 days. Of course, other balloon shapes may be employed and these Examples do not have to be limited to any one particular shape.

### Comparative Example 1

Example 1 was repeated with the exception that the application of the polymeric barrier layer (B) was omitted. The resulting balloon had a float life of only 4-7 days.

This application discloses several numerical ranges in the text and FIGURES. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

We claim:

1) A method comprising (i) obtaining a film comprising a base layer having a first side and a second side, the base layer comprising one or more polymers comprising polyester, and a barrier layer coextensively adjacent in contact with the first side of the base layer, and (ii) applying a metalized embossed holographic pattern on the barrier layer to form an holographically-decorated composite barrier film.

2) The method of claim 1, wherein the holographically-decorated composite barrier film has an oxygen transmission rate of about 0.005-0.2 cm3/100 in2/day (about 0.08-3.1 cm3/m2/day) and a moisture vapor transmission rate of about 0.05-0.13 g/100 in2/day (about 0.8-2 g/m2/day).

3) The method of claim 1, wherein the base layer comprises a first layer comprising crystalline polyester.

4) The method of claim 3, wherein the base layer further comprises a second layer comprising amorphous copolyester.

5) The method of claim 1, further applying a sealant layer on the second side of the base layer.

6) The method of claim 5, further applying an anchor layer between the base layer and the sealant layer.

7) The method of claim 1, further comprising sealing edges of the holographically-decorated composite barrier film to form an holographic envelope.

8) The method of claim 7, wherein the envelope is configured to be a lighter-than-air holographic envelope when the holographic envelope is filled with a lighter-than-air gas.

9) The method of claim 1, wherein the barrier layer comprises modified polyvinyl amine comprising a vinylamine polymer crosslinked by citric acid.

10) The method of claim 9, wherein the vinylamine polymer is polyvinyl alcohol/polyvinyl amine copolymer.

11) An holographically-decorated composite barrier film comprising (i) a metalized embossed holographic pattern, (ii) a base layer having a first side and a second side, the base layer comprising one or more polymers comprising polyester, and (iii) a barrier layer coextensively adjacent in contact with the first side of the base layer, the barrier layer comprising modified polyvinyl amine comprising a vinylamine polymer crosslinked by citric acid.

12) The composite barrier film of claim 11, wherein the holographically-decorated composite barrier film has an oxygen transmission rate of about 0.005-0.2 cm3/100 in2/day (about 0.08-3.1 cm³/m²/day) and a moisture vapor transmission rate of about 0.05-0.13 g/100 in²/day (about 0.8-2 g/m²/day).

13) The composite barrier film of claim 11, wherein the vinylamine polymer comprises polyvinyl alcohol/polyvinyl amine copolymer.

14) The composite film of claim 11, wherein the base layer comprises a first layer comprising crystalline polyester.

15) The composite barrier film of claim 14, wherein the base layer further comprises a second layer comprising amorphous copolyester.

16) The composite barrier film of claim 11, wherein the base layer thickness is 24-48 G (6-12 μm, preferably around 36 G (9 μm).

17) The composite barrier film of claim 11, wherein the polyester base layer comprises 70-99.9%, 90-99.9%, or 95-99.9% ethyleneterephthalate repeat units.

18) A lighter-than-air holographic envelope comprising the composite barrier film of claim 11.

19) The lighter-than-air holographic envelope of claim 18, wherein the lighter-than-air holographic envelope has a float life in excess of 7 days, 15 days, or 20 days.

20) A method of manufacturing the composite barrier film of claim 11, the method comprising: (i) forming the base layer with the base layer having a length in a first technical direction and a width in a second technical direction transverse to the first technical direction, (ii) stretching the base layer in the first technical direction by a stretch factor of about 1-3 times the length, (iii) applying a coating of an aqueous solution of vinylamine polymer and citric acid onto a surface of the base layer, (iv) simultaneously (a) crosslinking the vinylamine polymer with the citric acid to form the barrier layer of modified polyvinyl amine and (b) stretching the base layer in the second technical direction by a stretch factor of about 3-5 times the width, (v) applying a sealant layer by extrusion coating, (vi) applying an embossable coating onto the barrier layer, (vii) creating the embossing pattern on the embossable coating to form an embossed layer, and (vii) applying metal layer on top of the embossed layer.
